(19) United States
(12) Patent Application Publication
(10) Pub. No.: US 2023/0251859 A1
(43) Pub. Date: Aug. 10, 2023

(54) Indexing source code

(71) Applicant: Zdenek Tronicek, Stephenville, TX (US)

(72) Inventor: Zdenek Tronicek, Stephenville, TX (US)

(21) Appl. No.: 17/668,115

(22) Filed: Feb. 9, 2022

(51) Int. Cl. G06F 8/75

(52) U.S. Cl. CPC G06F 8/751

(57) ABSTRACT

A computer-implemented method of indexing source code is disclosed. Source code is processed to abstract syntax trees, the abstract syntax trees are linearized and the linearizations are used to build an index structure. The index structure enables one to look up the pattern tree in time linear in its length. In addition, the index structure can be used to identify code clones. Two variants of the index structure are claimed: one based on the trie, which is referred to as the plain index structure or simply the plain index, and one based on the compressed trie, which is referred to as the compressed index structure or simply the compressed index.

### STATEMENT REGARDING PRIOR DISCLOSURES BY THE INVENTOR OR A JOINT INVENTOR

The invention is described in the following journal paper, which is incorporated herein in its entirety: Zdenek Tronicek, Indexing source code and clone detection, Information and Software Technology, Volume 144, 2022, 106805, ISSN 0950-5849, https://doi.org/10.1016/|.infsof.2021.106805.

### BACKGROUND OF THE INVENTION

### Field of the Invention

The problem of tree pattern matching in abstract syntax trees (ASTs) commonly arises in a code recommendation system when it searches for code fragments and in Integrated Development Environment (IDE) when it performs operations on source code.

The motivation to investigate code clones stems from common software engineering tasks, such as development, maintenance, and bug fixing. For example, when the programmer writes a function, they may appreciate the information that the function already exists in the same code base, and when the programmer enhances a code fragment, they may want to know about all duplicates of that fragment.

Classification: G06F 8/75 Structural analysis for program understanding, G06F 8/751 Code clone detection

### Description of the Related Art Including Information Disclosed Under 37 CFR 1.97 and 1.98

There are only a few methods for indexing ASTs described in the literature and they are usually based on the suffix tree. The method described herein is based on the trie and compressed trie. Although the trie, compressed trie, and suffix tree are similar data structures, they are not the same. The suffix tree is a tree data structure that contains all suffices of a text and that can be represented in linear space. The trie, also known as the prefix tree, is built of independent strings (they are not required to be suffices of some string). The compressed trie (also called the compact trie), is a trie with edges labeled by strings instead of single characters. We can get a compressed trie from a trie by compressing the edges.

The methods for clone detection described in the literature can be divided into methods based on textual representation, methods based on tokens, methods based on ASTs, and other methods, such as methods based on metrics. The method described herein is based on ASTs.

The main improvement of the method described herein over existing methods is twofold: (i) the index described herein linearizes ASTs in a novel way, which results in more precise results, (ii) the linearizations of ASTs are arranged in a trie or compressed trie, which results in the index that can be easily modified to reflect the changes in source code. In the case of the index based on the suffix tree, we need to rebuild the index after each change (to date, we do not have any algorithm for modifying a suffix tree when the text changes). The possibility to modify the index after each change in source code makes the index suitable for reporting code clones “online” (after each change in source code) in Integrated Development Environment.

### BRIEF SUMMARY OF THE INVENTION

A computer-implemented method of indexing source code is disclosed. Source code is processed to ASTs, the ASTs are linearized and the linearizations are used to build an index structure. The index structure enables one to look up the pattern tree in time linear in its length. In addition, the index structure can be used to identify code clones. Two variants of the index structure are claimed: one based on the trie, which is referred to as the plain index structure or simply the plain index, and one based on the compressed trie, which is referred to as the compressed index structure or simply the compressed index. The disclosed invention has two advantages over the state-of-the-art methods: (i) the index described herein can be easily modified upon a change in source code and (ii) it provides significantly better results (in terms of precision and recall) when it is used to detect code clones.

### BRIEF DESCRIPTION OF THE SEVERAL VIEWS OF THE DRAWING(S)

The drawings in this application illustrate possible embodiments of the disclosure and together with the text description explain the principles of the disclosure. The drawings are considered a part of the specification; however, they illustrate only some possible embodiments. The intention of these illustrations is not to limit the invention to these particular embodiments.

FIGS. 1a and 1b depict a block diagram of a system that is an example embodiment of the disclosure. FIG. 2 is a flow chart of a method to identify code clones that is an example embodiment of the disclosure. FIG. 3 is a flow chart of a method to identify similar code fragments that is an example embodiment of the disclosure. FIG. 4 shows the abstract syntax trees of expressions (x + 2)/5 and x + y and one possible corresponding plain trie. The index structure consists of the trie and the positions associated with edges and/or nodes. FIG. 5 shows the abstract syntax trees of expressions (x + 2)/5 and x + y and one possible corresponding compressed trie. The compressed index structure consists of the compressed trie and the positions associated with edges and/or nodes.

### DETAILED DESCRIPTION OF THE INVENTION

The disclosure describes techniques for source-code indexing. The described techniques create an index of source code that can be used, for example, to find a fragment of code in a large code base or to detect the same or similar code fragments in a large code base. Upon a change in the code base, the index can be modified so that it reflects that change.

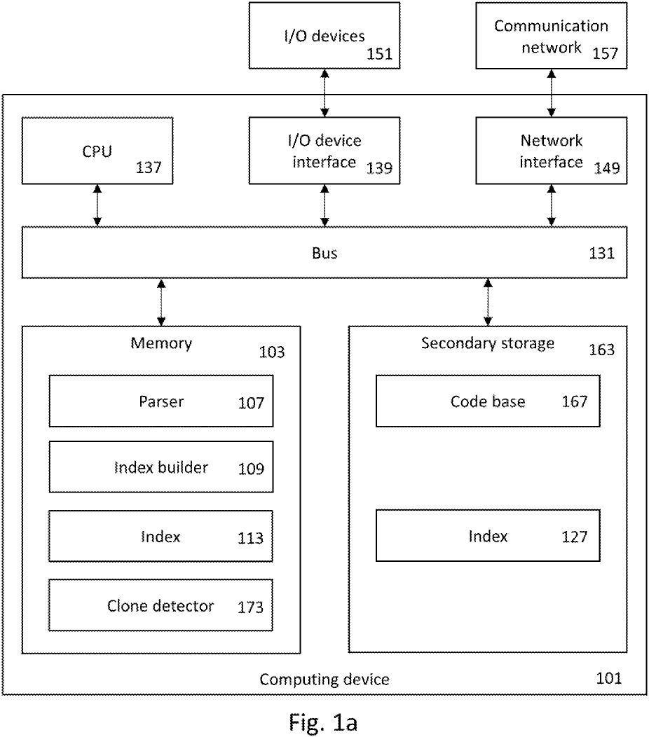

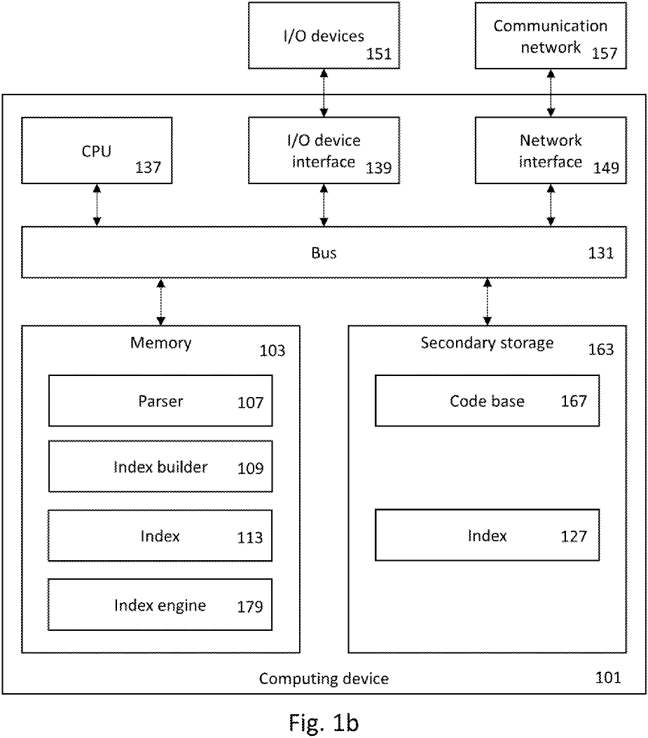

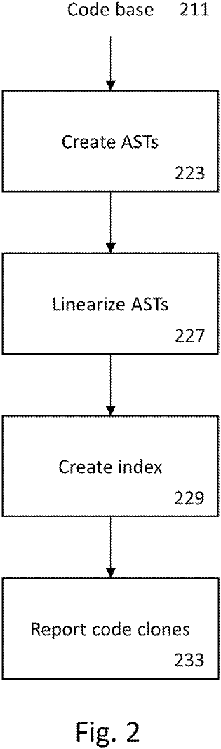

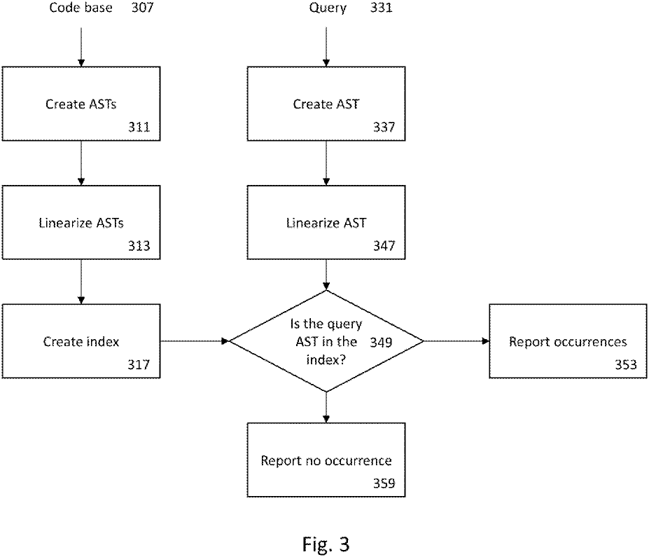

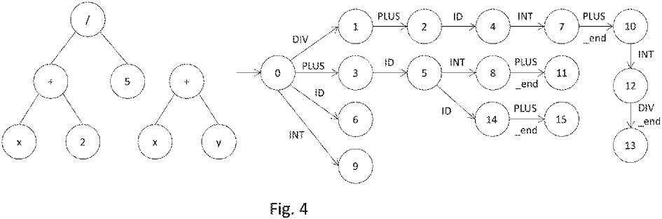

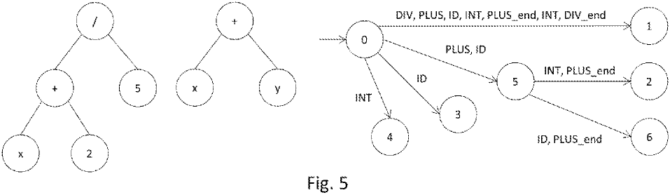

FIGS. 1a and 1b illustrate an example of computer architecture that implements the described techniques for source-code indexing and clone detection. These figures share some components, which are described here just once.

The following description applies to both FIGS. 1a and 1b: The computer architecture may include a computing device 101, which may be a part of a distributed system and may communicate with other computing devices via a network interface 149 and communication network 157. The communication network 157 represents any one or combination of multiple different types of networks interconnected with each other and functioning as a single network, such as the Internet. It may involve wire-based networks and wireless networks. The computing device may be operated by a user via input/output devices 151, such as a keyboard, mouse and monitor, which may be connected to input/output device interface 139. The computing device 101 may include one or more processors 137, memory 103 and secondary storage 163. A processor executes instructions stored in memory 103 or on secondary storage 163 and stores and retrieves data residing in memory 103 or on secondary storage 163. The bus 131 is used for communication between the processor 137, I/O device interface 139, network interface 149, memory 103 and secondary storage 163. The memory 103 may contain parser 107, the index builder 109 and the index structure 113. The secondary storage 163 may contain the code base 167 and the index structure 113. The index structure may be present only in memory or only on secondary storage or partially in memory and partially on secondary storage. The parser parses the code base 167 and builds abstract syntax trees (ASTs). The code base 167 is a collection of source code of programming projects. The parser may be a stand-alone program or it may be a part of another program, such as a compiler, or any combination of programs. The index builder 109 linearizes the ASTs built by the parser and builds the index structure 113.

In FIG. 1a, the clone detector 173 uses the index structure 113 to detect code clones.

In FIG. 1b, the index engine 179 uses the index structure 113 to find occurrences of a code fragment (query) in the code base 167. It uses parser 107 to convert a code fragment to an AST, then it linearizes that structural representation, and finally it finds occurrences of the linearization in the index structure 113.

The index structure is described here for the Java programming language; however, the concept is applicable to any programming language. Java code is structured into packages, classes, and methods, which is the terminology used in this text. For procedural languages, we would substitute “function” for “method”. The index structure is here referred to as the index, but it is not a common index because it does not find patterns that span two syntactic units. For example, it does not find a fragment of code that begins in one statement and ends in another statement, or a fragment of code that begins in one method and ends in another method.

The index structure can be full or simplified and either of them can use either the trie or the compressed trie. The trie and the compressed trie (sometimes called compact trie or radix tree) are fundamental data structures, which are well described in the literature. The difference between them is that the edges of the trie are labeled by symbols and the edges of the compressed trie are labeled by sequences of symbols. Whenever it is appropriate to emphasize that the trie is not compressed, it is referred to as the plain trie. The index structure consists of the plain trie or compressed trie and positions associated with edges and/or nodes. These positions refer to the code base.

The full index can be built in two steps:
1. Parse source code and build ASTs of methods.
2. Linearize subtrees of the ASTs and build a trie (plain or compressed) that accepts all these linearizations, and add positions of these subtrees in the code base to edges and/or nodes of the trie.

The simplified index can also be built in two steps:
1. Parse source code and build ASTs of syntactic units, such as methods and statements.
2. Linearize the ASTs of each syntactic unit and build a trie (plain or compressed) that accepts all these linearizations, and add positions of the ASTs in the code base to edges and/or nodes of the trie.

The linearization captures the structure of the ASTs and it is done as follows: we concatenate node representations and special symbols, which are added at the end of each subtree (except for subtrees that are of a single node that cannot have children). When linearizing ASTs, we may consider all literals equal and may rename identifiers or consider all identifiers equal so that the index depends rather on the code structure than on concrete values of literals and concrete identifiers. For example, when we linearize the subtrees of ASTs in FIG. 4, we may get the following linearizations for the first tree (PLUS_end and DIV_end are special symbols at the end of the tree):
DIV, PLUS, ID, INT, PLUS_end, INT, DIV_end (the whole tree),
PLUS, ID, INT, PLUS_end (the subtree rooted at node “+”),
ID (the subtree rooted at node x),
INT (the subtrees rooted at nodes 2 and 5).
And the following linearizations for the second tree:
PLUS, ID, ID, PLUS_end (the whole tree),
ID (the subtrees rooted at nodes x and y).
The symbols used in this example, such as DIV and PLUS, are only for illustrative purposes and the embodiment may use different symbols.

The special symbols are also added in other cases than at the end of each subtree, such as when a node refers to a list of subtrees. For example, to distinguish between “class C extends Object” and “class C implements Serializable”, we need to add a mark at the beginning and at the end of the list of implemented interfaces. When analyzing a statically typed language, we may add information about the types of variables, which enables us to distinguish between two trees with the same structure but different types. For example, if variable x in FIG. 4 is of type int, the linearization of the first tree may be DIV, PLUS, ID:INT, INT, PLUS_end, INT, DIV_end, where ID:INT represents a variable of type int. The symbols used in this example, such as DIV and PLUS, are only for illustrative purposes and the embodiment may use different symbols.

Another possible linearization of the ASTs is to concatenate representations of corresponding lexical symbols (i.e., symbols of the lexical analyzer). Since the structural representation is not needed in this case, parsing can be simplified to recognizing the boundary of syntactic units.

The index structure can be used to report code clones. A clone is a code fragment that is duplicated somewhere else in the same code base or in another code base. We usually divide clones into four categories:
i. Type 1 (exact clone) is the exact copy of the code fragment. There can be changes only in white spaces and comments.
ii. Type 2 (renamed clone) is a syntactically identical copy and it appears, for example, when we copy a code fragment modify literals and change (“rename”) identifiers of types, variables and methods in that fragment. As in Type 1, changes in white spaces and comments are allowed. A subset of renamed clones is parameterized clones, which are syntactically identical code fragments with modified literals and systematically renamed identifiers of types, variables and methods.
iii. Type 3 (near-miss clone) is a “renamed” code fragment with some structural modifications. For example, some statements are modified, added, or removed.
iv. Type 4 (semantic clone) is a code fragment that is semantically equivalent to the original code fragment, but syntactically may be different. For example, when we replace an algorithm with another one that gives the same results, the two code fragments are functionally equivalent, but they are syntactically different.
The index structure can be used to find Type-1 and Type-2 clones as follows: we traverse the trie and report the linearizations that are associated with more than one position in source code. The following algorithm illustrates how the index can be used to report Type-2 clones. The algorithm assumes that positions in source code are associated with edges. Algorithm: Find Type-2 clones
1. Build the index.
2. Start in the root and traverse the index. When you come to a node that has no outgoing edge (which corresponds to the end of the tree): if the edge to this node is associated with more than one position in source code, report a clone.

The index structure can be employed in syntactic search, which searches for a fragment of code based on its structural representation. Searching for a fragment of code is very straightforward: we linearize its AST and check whether the index structure contains the linearization. If the index structure contains the linearization, we report positions associated with the last edge and/or node of the path from the root labeled with the linearization.

Although syntactic search is very precise, especially when we search for a pattern exactly (when no deviation from the pattern is allowed), the result does not have to fulfill our expectations. For example, when searching for pattern “if (x == 0) y = 1;”, we may expect to find “if (x == 0) {y = 1; }” as well, but if these two patterns are linearized to different linearizations, the occurrences of the latter are not reported. Another example is an expression with superfluous parentheses. For example, when searching for “return x + y”, we may also want to find “return (x + y)”. In order to be able to report these syntactically equivalent trees, we may transform subject trees to a “normalized” form with a block instead of a single statement and with no parentheses. Some examples (not exhaustive) of possible normalization are as follows:
arithmetic expressions (e.g., “1 + x” can be normalized to “x + 1”),
equality/inequality tests (e.g., “b == false” can be normalized to “!b″ and “null != p” can be normalized to “p != null”),
relational tests (e.g., “0 > p” can be normalized to “p < 0”),
assignments (e.g., “x += 1” can be normalized to “x++” and “y = y + 2” can be normalized to “y += 2”),
infinite loops (e.g., “while (true)” can be normalized to “for ( ; ; )”),
if statements (e.g., “if (!b) s1 else s2” can be normalized to “if (b) s2 else s1” and “if (b) return true; else return false;” can be normalized to “return b;”),
conditional operators (e.g., “!b ? e1 : e2” can be normalized to “b ? e2 : e1”).
When searching for a pattern, we may do the same transformation on the pattern tree.

One possible use of the described system involves a software developer who works on the code base: during their work, such as when they write a new method, clones of that method are looked up and reported to the developer or used to recommend a library. Another possible use involves automated code completion: when the developer writes the beginning of a method, the method is looked up in the code base and automatically completed. Yet another possible use involves a search engine, which reports occurrences of code fragments in one or more code repositories. All these possible uses are presented only for illustrative purposes. They are not intended to be exhaustive and they do not limit possible embodiments of this disclosure.

Any of the components depicted in FIGS. 1a and 1b may be a module of computer-executable instructions, which are instructions executable on a computer, computing device, or the processors of a computer. The components are shown here as modules, but they may be embodied as hardware, software or any combination of hardware and software. They are depicted here as residing on the computing device, but they may be distributed across many computing devices in a distributed system.

FIG. 2 displays a flowchart of a possible embodiment of this disclosure. The embodiment uses the index structure to report code clones. The code base 167 is a collection of the source code of programming projects. It is parsed to ASTs (step 223), the ASTs are linearized (step 227), the linearizations are used to build the index (step 229), and the index is used to report code clones (step 233).

FIG. 3 displays another flowchart of a possible embodiment of this disclosure. The embodiment uses the index structure to search for a fragment of code. The code base 167 is a collection of the source code of programming projects. It is parsed to ASTs (step 223), the ASTs are linearized (step 227), and the linearizations are used to build the index (step 229), which can be repeatedly used to answer the question of whether the code base contains a specified code fragment. To find a code fragment (query) 331 in the code base 167, the code fragment 331 is parsed to an AST (step 337), the AST is linearized (step 347) and the linearization is searched for in the index (step 349). If the index contains the linearization, the occurrences of the pattern are reported (step 353), otherwise, no occurrence is reported (step 359).

FIG. 4 shows the abstract syntax trees of expressions (x + 2)/5 and x + y and one possible corresponding plain trie. The index structure consists of the trie and the positions associated with edges and/or nodes of the trie.

FIG. 5 shows the abstract syntax trees of expressions (x + 2)/5 and x + y and one possible corresponding compressed trie. The compressed index structure consists of the compressed trie and the positions associated with edges and/or nodes of the compressed trie.

The descriptions of various embodiments of this disclosure, such as examples in FIGS. 2, 3, 4 and 5, are presented only for illustrative purposes. They are not intended to be exhaustive and they do not limit possible embodiments of this disclosure. Many modifications and variations of principles described in this disclosure will be apparent to those who have ordinary skills in the art.

### SEQUENCE LISTING

Not Applicable

What is claimed is:

1. A method implemented by one or more computing devices configured to detect code clones in one or more code bases and/or search for a code fragment in one or more code bases, each computing device of the one or more computing devices including at least one or more memory devices and one or more secondary storage devices, the method comprising:
a. processing source code including one or more code bases to build an index structure, the processing comprising at least the steps of:
i. parsing the source code to generate one or more abstract syntax trees (ASTs);
ii. linearizing subtrees of the ASTs and building a trie comprising the linearized subtrees, wherein the trie is either plain or compressed, the trie comprising a plurality of nodes and one or more edges; and
iii. adding positions of elements of the subtrees in the source code to edges and/or nodes of the trie;
b. wherein the index structure comprises the trie, and the index structure is either full or simplified;
c. storing the index structure in the one or more memory devices, the one or more secondary storage devices, or a combination of one or more of the memory devices and one or more of the secondary storage devices; and
d. using the index structure to identify code clones and/or find a code fragment.

2. A computing device comprising:
a. one or more processors, and
b. one or more secondary storage storing instructions, the instructions executable by one or more processors to perform operations comprising processing source code including one or more code bases to build an index structure that is used to detect code clones in one or more code bases and/or search for a code fragment in one or more code bases; the processing comprising at least the steps of:
i. parsing the source code to generate one or more abstract syntax trees (ASTs);
ii. linearizing subtrees of the ASTs and building a trie comprising the linearized subtrees, wherein the trie is either plain or compressed, the trie comprising a plurality of nodes and one or more edges; and
iii. adding positions of elements of the subtrees in the source code to edges and/or nodes of the trie;
c. wherein the index structure comprises the trie, and the index structure is either full or simplified;
d. storing the index structure in the one or more memory devices, the one or more secondary storage devices, or a combination of one or more of the memory devices and one or more of the secondary storage devices; and
e. using the index structure to identify code clones and/or find a code fragment.

3. A memory device storing processor-executable instructions that, when executed, cause one or more processors to perform operations comprising processing source code including one or more code bases to build an index structure that is used to detect code clones in one or more code bases and/or search for a code fragment in one or more code bases; the processing comprising at least the steps of:
a. parsing the source code to generate one or more abstract syntax trees (ASTs);
b. linearizing subtrees of the ASTs and building a trie comprising the linearized subtrees, wherein the trie is either plain or compressed, the trie comprising a plurality of nodes and one or more edges; and
c. adding positions of elements of the subtrees in the source code to edges and/or nodes of the trie;
wherein the index structure comprises the trie, and the index structure is either full or simplified; the trie is either plain or compressed; the positions are associated with edges and/or nodes of the trie.
